(19) United States
(12) Patent Application Publication
(10) Pub. No.: US 2009/0213060 A1
(43) Pub. Date: Aug. 27, 2009

(54) DISPLAY DEVICE

(75) Inventors: Kozo YASUDA, Mobara (JP); Katsumi Matsumoto, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Displays, Ltd.

(21) Appl. No.: 12/392,124

(22) Filed: Feb. 25, 2009

(30) Foreign Application Priority Data
Feb. 26, 2008 (JP) 2008-043793

(51) Int. Cl. G09G 3/36; H04N 3/14

(52) U.S. Cl. 345/94; 348/790

(57) ABSTRACT

A display device includes, in each pixel including a pixel electrode and a counter electrode with liquid crystal therebetween, a memory part which stores video data written to the pixel electrode and a switch part which applies a first video voltage to the counter electrode and selects and applies the first video voltage or a second video voltage which is obtained by inverting the first video voltage to the pixel electrode in accordance with the video data stored in the memory part, in which a liquid crystal inversion AC cycle during which the first video voltage and the second video voltage are driven such that a magnitude of the first video voltage and a magnitude of the second video voltage are exchanged in a predetermined cycle is set longer than a rewrite cycle of video data to the pixel electrode.

### CROSS-REFERENCE TO RELATED APPLICATIONS

The disclosure of Japanese Patent Application No. 2008-43793 filed on Feb. 26, 2008 including the specification, drawings and abstract is incorporated herein by reference in its entirety.

### BACKGROUND

1. Field of the Invention

The present invention relates to a display device and more particularly to a display device including a memory part in each pixel.

2. Description of Related Arts

As a liquid crystal display device used for a mobile phone or the like, for example, a liquid crystal display device which includes a memory in each pixel and makes the memory store display data, thereby displaying an image thereon even when input data is not supplied from the outside has been known (refer to Japanese Patent Laid-Open No. 2006-285118).

For example, this eliminates the necessity of the rewrite operation of video in the display of a still image, thereby making it possible to configure a liquid crystal display device of low power consumption.

### SUMMARY

On the other hand, for example, a liquid crystal display device performs the so-called liquid crystal inversion AC drive in order to prevent the deterioration of liquid crystal of the liquid crystal display device due to polarization.

In this case, since it is difficult to hold data (video signal) in the liquid crystal for a long time in liquid crystal display, the data must be rewritten every 1/60 sec, for example. At this time, the liquid crystal inversion AC drive is performed simultaneously in general.

This is because display cannot be performed correctly unless the video signal applied to the liquid crystal is also inverted simultaneously with the inversion AC drive of the liquid crystal.

Therefore, a liquid crystal inversion AC cycle is the same as a video data rewrite cycle and thereby must be set extremely short.

This means that the charging and discharging current of a liquid crystal capacitor is large at the time of the liquid crystal inversion AC drive, leading to an increase in power consumption.

It is an object of the invention to provide a display device which includes a memory part in each pixel and intends to reduce power consumption.

A typical outline of the invention disclosed in the present application will be described below.

(1) The invention is directed to a display device which includes, for example, in each pixel including a pixel electrode and a counter electrode with liquid crystal therebetween, a memory part which stores video data written to the pixel electrode, and a switch part which applies a first video voltage to the counter electrode and selects and applies the first video voltage or a second video voltage which is obtained by inverting the first video voltage to the pixel electrode in accordance with the video data stored in the memory part, in which a liquid crystal inversion AC cycle during which the first video voltage and the second video voltage are driven such that a magnitude of the first video voltage and a magnitude of the second video voltage are exchanged in a predetermined cycle is set longer than a rewrite cycle of video data to the pixel electrode.

(2) The invention is directed to a display device in which, for example, on the premise of the configuration of (1), the first video voltage is generated by reducing a frequency of a signal from an oscillator, and the second video voltage is generated by output of the first video voltage via an inverter.

(3) The invention is directed to a display device in which, for example, on the premise of the configuration of (2), an oscillation frequency of the oscillator is determined by a time constant based on a resistor and a capacitor which are provided in the oscillator, and the oscillation frequency is reduced by a countdown circuit.

(4) The invention is directed to a display device in which, for example, on the premise of the configuration of (1), the second video voltage is obtained from output of an inverter to which the first video voltage is input.

The invention is not limited to the above configurations and can be variously modified within the range not departing from the technical idea of the invention.

According to the thus configured display device, power consumption can be reduced.

### BRIEF DESCRIPTION OF THE DRAWINGS

FIG. 1 shows an embodiment of a circuit which is provided in a display device according to the invention and generates liquid crystal inversion AC, showing an oscillator, a countdown circuit, and an inverter;

FIG. 2 is a schematic configuration view showing an embodiment of a display device according to the invention;

FIG. 3 shows signals for liquid crystal inversion AC in a display device according to the invention; and

FIG. 4 is a circuit diagram showing an embodiment of a pixel of a display device according to the invention.

### DETAILED DESCRIPTION OF THE INVENTION

Hereinafter, an embodiment of a display device according to the invention will be described by using the drawings.

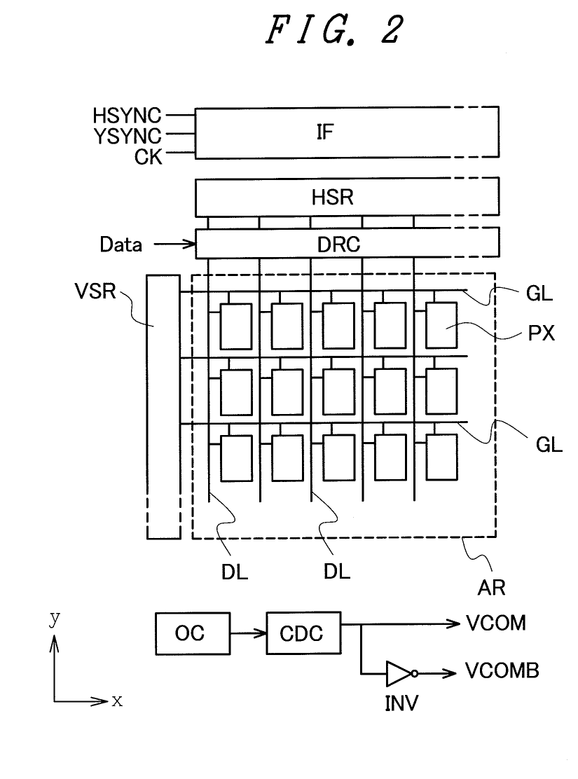

FIG. 2 is a schematic configuration view showing an embodiment of a display device according to the invention. FIG. 2 shows, for example, a liquid crystal display device as an example.

An equivalent circuit shown in FIG. 2 is formed above a substrate made of, for example, glass which constitutes an outer casing of the liquid crystal display device (liquid crystal display panel).

A liquid crystal display area AR is formed on the surface of the substrate, and a plurality of pixels PX are formed in a matrix arrangement in the liquid crystal display area AR. As will be described later, each of the pixels PX is provided with a memory part so that an image can be displayed on the liquid crystal display area AR even when an input signal is not supplied from the outside.

Each of the pixels PX arranged in the row direction (x direction in the drawing) is supplied with a scanning signal from a common scanning line GL, while each of the pixels PX arranged in the column direction (y direction in the drawing) is supplied with a video signal from a common video line DL.

Each of the scanning lines GL is connected to a vertical shift register VSR at the left end in the drawing, for example, and sequentially supplied with a scanning signal from the vertical shift register VSR. The vertical shift register VSR is driven by a drive signal from an interface circuit IF.

For example, a horizontal synchronizing signal HSYNC, a vertical synchronizing signal VSYNC, and a clock CK are input from an external circuit of the liquid crystal display device to the interface circuit IF, by which a drive signal is generated to drive the vertical shift register VSR.

In addition, the interface circuit IF drives a horizontal shift register HSR, and by driving a data latch circuit DRC to which data (video signal) is input from an external circuit of the liquid crystal display device, the horizontal shift register HSR inputs the data (video signal) to each of the video lines DL.

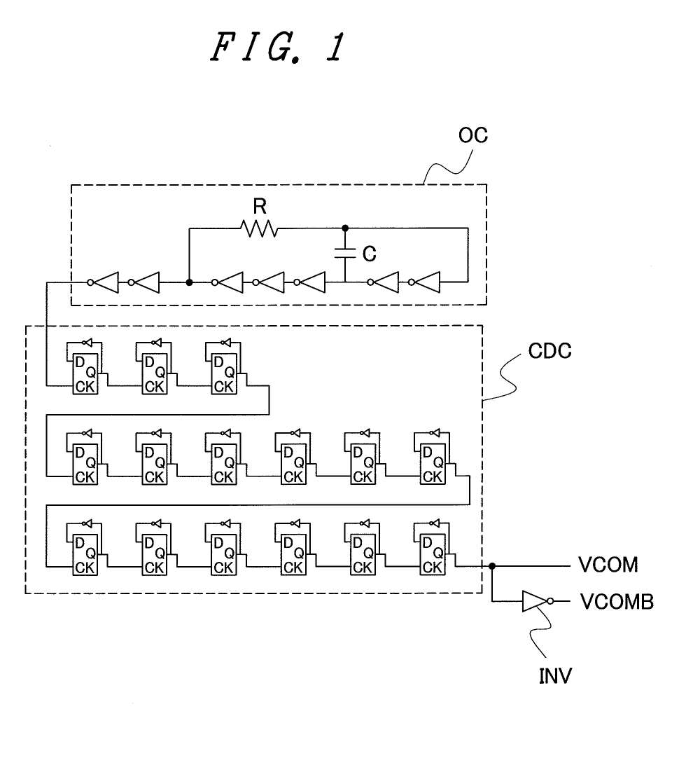

On the other hand, an the substrate formed with each of the circuits, an oscillator OC, a countdown circuit CDC, and an inverter INV are formed. The specific configurations of these circuits are shown in FIG. 1, for example.

A VCOM signal and a VCOMB signal, both described later, are obtained from these circuits, and the AC drive of liquid crystal is performed with these signals.

These circuits may be disposed as external circuits of the liquid crystal display device.

A signal from the oscillator OC is output at a frequency which is determined by the time constant of a resistor R and a capacitor C which are provided in the oscillator OC. The oscillator OC operates stably against a fluctuation in power supply voltage or the like.

Since the oscillation frequency of the oscillator OC is as high as about several tens KHz, the frequency of the signal from the oscillator OC is reduced to an appropriate value by the countdown circuit CDC. The countdown circuit CDC is formed of multistage-connected flip-flop circuits each including an inverter.

A signal from the countdown circuit CDC is used as the VCOM signal, and a signal obtained by inverting the VCOM signal by the inverter INV is used as the VCOMB signal.

The VCOM signal is supplied to a counter electrode facing a pixel electrode of each of the pixels PX, and either the VCOM signal or the VCOMB signal is supplied to the pixel electrode.

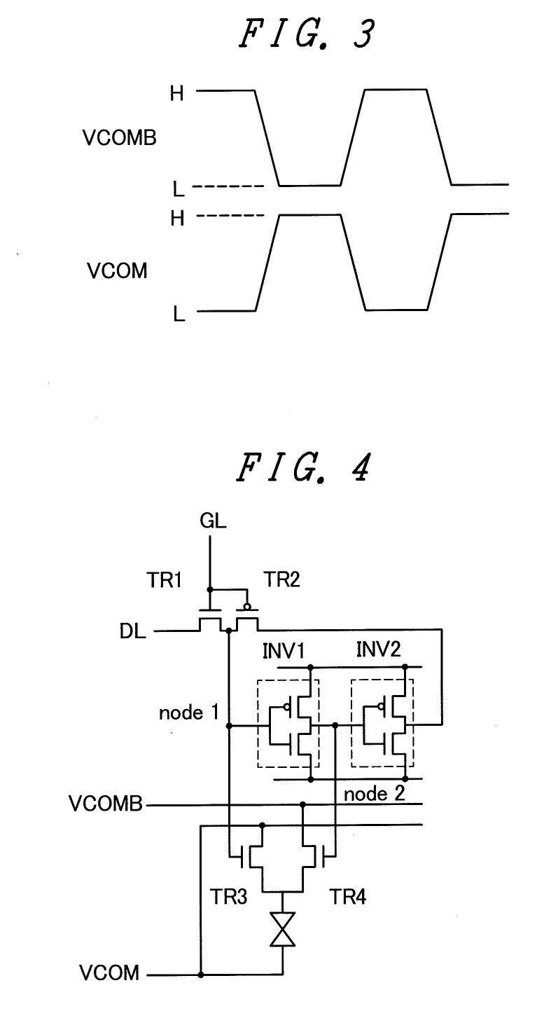

For the VCOM signal and the VCOMB signal which are supplied to the pixel electrode and the counter electrode, the voltage of the VCOM signal and the voltage of the VCOMB signal obtained by inverting the VCOM signal are changed in accordance with a common inversion cycle as shown in FIG. 3. The voltage of the VCOM signal is inverted between an L level (0 V, for example) and an H level (5 V, for example) in accordance with the common inversion cycle. When the voltage of the VCOM signal is at the L level, the voltage of the VCOMB signal is at the H level, while the voltage of the VCOM signal is at the H level, the voltage of the VCOMB signal is at the L level. That is, the magnitude of the voltage of the VCOM signal and the magnitude of the voltage of the VCOMB signal are exchanged in a predetermined cycle so that the AC drive of liquid crystal is performed. This is performed in order to prevent the generation of the polarization of liquid crystal.

FIG. 4 shows an embodiment of an equivalent circuit in the pixel PX.

In FIG. 4, a memory part which is formed of a first inverter INV1 and a second inverter INV2 connected together in a ring form is provided.

The first inverter INV1 is connected to a node ND1 at the input terminal thereof and connected to a node ND2 at the output terminal thereof. The second inverter INV2 is connected to the node ND2 at the input terminal thereof and connected to the node ND1 at the output terminal thereof (via a transistor TR2).

The transistor TR2 is turned ON during the holding operation of the memory part.

Data (“1” or “0”) from the video line DL is written to the node ND1 via a transistor TR1.

When the data “1” is written to the node ND1, a transistor TR3 is turned ON to apply the potential of the VCOM signal to a pixel electrode. At this time, data at the node ND2 is “0”, and a transistor TR4 is turned OFF.

When the data “0” is written to the node ND1, the transistor TR3 is turned OFF, and the transistor TR4 is turned ON with the data “1” at the node ND2. The transistor TR4 is turned ON so that the potential of the VCOMB signal is applied to a pixel electrode.

The pixel electrode generates an electric field between the pixel electrode and a counter electrode which is disposed to face the pixel electrode via liquid crystal LC. The potential of the VCOM signal is applied to the counter electrode.

As described above, the voltage of the VCOMB signal is a voltage which is obtained by inverting the voltage of the VCOM signal by the inverter INV.

In FIG. 4, when a scanning line selection signal is input from the vertical shift register VSR to the scanning line GL, the transistor TR1 is turned ON, and the transistor TR2 is turned OFF. At this time, the data (“1” or “0”) from the video line DL is written to the node ND1 via the transistor TR1.

While when a scanning line non-selection signal is input to the scanning line GL, the transistor TR1 is turned OFF, and the transistor TR2 is turned ON.

At this time, the data written to the node ND1 is held in the memory part formed of the first inverter INV1 and the second inverter INV2.

In this case, in the case of the so-called normally white liquid crystal display panel, a white display is performed in a pixel when the data “1” and the data “0” are written to the node ND1 and the node ND2, respectively, while a black display is performed when the data “0” and the data “1” are written to the node ND1 and the node ND2, respectively.

By providing the memory part in a pixel as described above, the operation of the horizontal shift register HSR and the vertical shift register VSR can be stopped when it is unnecessary to rewrite an image on a display part, whereby power consumption can be reduced.

As another embodiment according to the invention, a configuration in which the so-called area gray scale is adopted for each pixel maybe employed. That is, a plurality of divided pixel electrodes each having a different area are formed in each pixel, and the circuit shown in FIG. 4 is formed in each of the pixel electrodes.

One of the plurality of pixel electrodes is selected, or they are selected in combination with one another so that a predetermined gray scale display becomes possible.

The thus configured liquid crystal display device can drive a cycle (liquid crystal inversion AC cycle) during which the first vide voltage and the second video voltage are driven such that the magnitude of the first video voltage and the magnitude of the second video voltage are exchanged in a predetermined cycle independently of a cycle (video data rewrite cycle) necessary for rewriting the video data to the pixel electrode.

Therefore, by utilizing the above fact, in the invention, the liquid crystal inversion AC cycle is set longer than the video data rewrite cycle so that power consumption is greatly reduced.

That is, in the liquid crystal display device, power consumption necessary for storing data in the memory part is generated due to leak current generated in the memory part and charging and discharging current generated upon the liquid crystal inversion AC drive. In this case, the power consumption due to the charging and discharging current generated upon the liquid crystal inversion AC drive is large.

The amount of the charging and discharging current generated upon the liquid crystal inversion AC drive has a proportional relationship with the liquid crystal inversion AC cycle, and therefore, consumption current is more reduced as the liquid crystal inversion AC cycle is set longer.

In view of the above, in the invention, the liquid crystal inversion AC cycle is set, for example, every plural frames, every several seconds, every several minutes, every several hours, or the like, and set longer than the video data rewrite cycle.

Although the liquid crystal display device is shown as an example of the above-described display device, it is needless to say that the display device may be other display device such as an organic electroluminescent display device.

Each of the above-described embodiments may be used alone or in combination. This is because the advantageous effects of the respective embodiments can be obtained individually or synergistically.

What is claimed is:

1. A display device comprising:
in each pixel including a pixel electrode and a counter electrode which control liquid crystal,
a memory part which stores video data written to the pixel electrode; and
a switch part which applies a first video voltage to the counter electrode and selects and applies the first video voltage or a second video voltage which is obtained by inverting the first video voltage to the pixel electrode in accordance with the video data stored in the memory part, wherein
a liquid crystal inversion AC cycle during which the first video voltage and the second video voltage are driven such that a magnitude of the first video voltage and a magnitude of the second video voltage are exchanged in a predetermined cycle is set longer than a rewrite cycle of video data to the pixel electrode.

2. The display device according to claim 1, wherein
the first video voltage is generated by reducing a frequency of a signal from an oscillator, and
the second video voltage is generated by output of the first video voltage via an inverter.

3. The display device according to claim 2, wherein
an oscillation frequency of the oscillator is determined by a time constant based on a resistor and a capacitor which are provided in the oscillator, and
the oscillation frequency is reduced by a countdown circuit.

4. The display device according to claim 1, wherein
the second video voltage is obtained from output of an inverter to which the first video voltage is input.
